(19) United States
(12) Patent Application Publication
(10) Pub. No.: US 2013/0074358 A1
(43) Pub. Date: Mar. 28, 2013

(54) HEATED BODY WITH HIGH HEAT TRANSFER RATE MATERIAL AND ITS USE

(71) Applicant: Quantum Technology Holdings Limited, Hong Kong (CN)

(72) Inventors: Yu Zhi Qu, Hong Kong (CN); Ki Chan, Hong Kong (CN)

(73) Assignee: Quantum Technology Holdings Limited, Hong Kong (CN)

(21) Appl. No.: 13/625,629

(22) Filed: Sep. 24, 2012

Related U.S. Application Data
(60) Provisional application No. 61/538,834, filed on Sep. 24, 2011.

(51) Int. Cl. H05B 3/06; F26B 3/00

(52) U.S. Cl. 34/282; 219/521

(57) ABSTRACT

An apparatus including a body; a plurality of heating tubes adjacent an interior surface of the body; a plurality of heating elements disposed in a portion of respective ones of the plurality of heating tubes; and a thermally conductive material disposed in the plurality of heating tubes. A method including contacting a substrate with a dryer, the dryer including a cylindrical body; a plurality of heating tubes disposed around the cylindrical body; a plurality of heating elements disposed in the plurality of heating tubes; a thermal conducting material disposed in the plurality of heating tubes; and removing moisture from the substrate. A method including contacting a substrate with a body heated by a plurality of heating tubes including a heating element and a thermally conductive material. An apparatus including a body, a heat element and a thermally conductive material disposed in a volume of the body.

### CROSS-REFERENCE TO RELATED APPLICATION

The application claims the benefit of the earlier filing date of co-pending U.S. Provisional Patent Application No. 61/538,834, filed Sep. 24, 2011 and incorporated herein by reference.

### BACKGROUND

Dying operations are often an important part of many commercial production processes. Cylindrical or roller drying for example, is a significant component used in the production of paper, textiles, printing and dyeing and non-woven fabric industries.

Continuous or large scale paper production involves the conversion of a pulp (e.g., wood pulp) into a final paper product through a series of sections. In general, the sections of a paper making process are: (1) a forming section where a slurry of fibers is filtered out of a continuous fabric loop to form a wet web of fiber; (2) a pressed section where the wet fiber passes between large rolls loaded under high pressure; (3) drying section where the pressed sheet passes around heated drying cylinders or rollers and the water content of the pressed sheet is reduced to on the order of six percent; and (4) a calendar section where cylinder or rollers smooth the dried sheet. With reference to the drying section, Conventional cylindrical or roller dryers utilize steam, fossil fuels or electric heating of heavy oil as heat sources. These heat sources require fuel at the source, such as facilities like coal storage bunkers, gas storage rooms, boiler rooms, etc. Such facilities also often require a large quantity of water which can cause environmental pollution and increased investment costs. Further, a large number of pressure vessel equipment and flammable raw material storage tends to bring high risk to the safety of the production process.

Other disadvantages to traditional heating sources for drying cylinders or rollers is the thermal efficiency of steam, fossil fuel or electric heating of heavy oil drying is relatively low. During the production process the operating temperature of a drying cylinder or roller can directly affect the quality of the product and the scale of the production. Moreover, the operating temperature of these drying cylinders or rollers often cannot attain the ideal processing temperature and it is further often hard to control and adjust the temperature when there is a change of material being processed. Finally, steam and fossil fuel drying cylinders or rollers and heavy oil electric heating methods normally require several hours (e.g., 3 hours) of preheating which can prolong the production time.

### BRIEF DESCRIPTION OF THE DRAWINGS

FIG. 1 shows a schematic of a paper production system.

FIG. 2 shows a perspective top side view of an embodiment of a roller of the drying section of the paper production system of FIG. 1.

FIG. 3 shows a exploded side view of the cylinder or roller of FIG. 2.

FIG. 4 shows a cross-sectional side view through line 4-4′ of FIG. 3.

FIG. 5 shows a magnified cross-sectional side view of a portion of the assembled cylinder or roller of FIG. 3.

FIG. 6 shows an embodiment of one heating tube of the cylinder or roller of FIG. 3 including a heating rod and a thermally conductive material.

FIG. 7 shows a temperature curve diagram for heating a cylinder or roller such as that described with reference to FIGS. 2 and 3.

### DETAILED DESCRIPTION

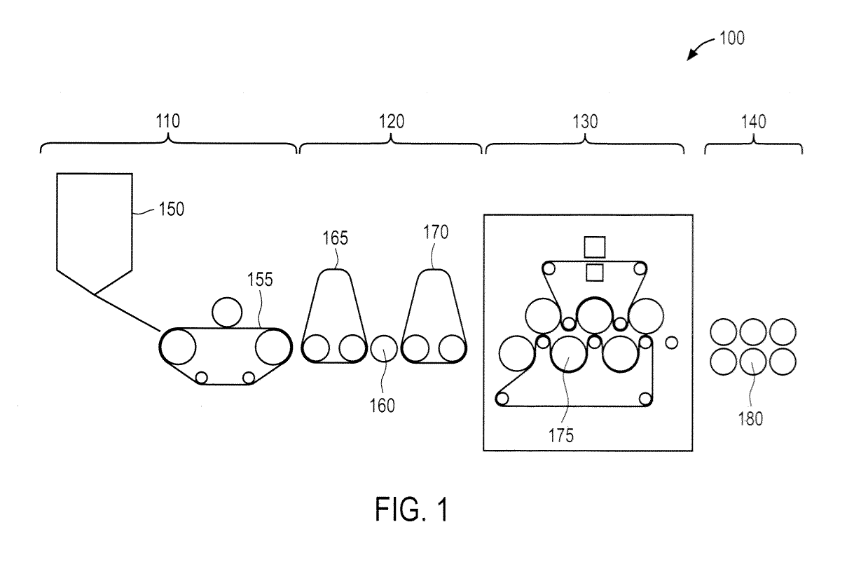

FIG. 1 shows a schematic representation of a paper production system. System 100 includes a number of sections. A shown in FIG. 1, the system includes forming section 110 where a wet pulp is collected in head box 150 and fibers are dispensed onto a moving fabric loop or wire 155 and moved to press section 120. Press section 120 removes most of the water in the product by way of system of nips formed by rolls 160 pressing against each other aided by pressed belts 165, 170 that support the product and absorb the pressed water. From press section 120, the product sheet is moved to dryer section 130 which dries the product by way of a series of internally heated cylinders 175 that evaporate the moisture. The product is typically held against the dryers by a felt loop on the top and bottom of each dryer section. The drying cylinders or rollers are typically arranged in groups called sections so that they can be run at progressively slightly slower speed to compensate for sheet shrinkage as the product dries. From drying section 130, the product is moved to calendar section 140 that consists of a number of rolls 180, vertically stacked, that apply pressure and heat to the passing product. Calendar section 140 is used to make the product smooth and glossy and give it a uniform thickness after calendaring the product at a moisture content of for example about six percent. The product is wound onto a roll and stored for final cutting and shipping.

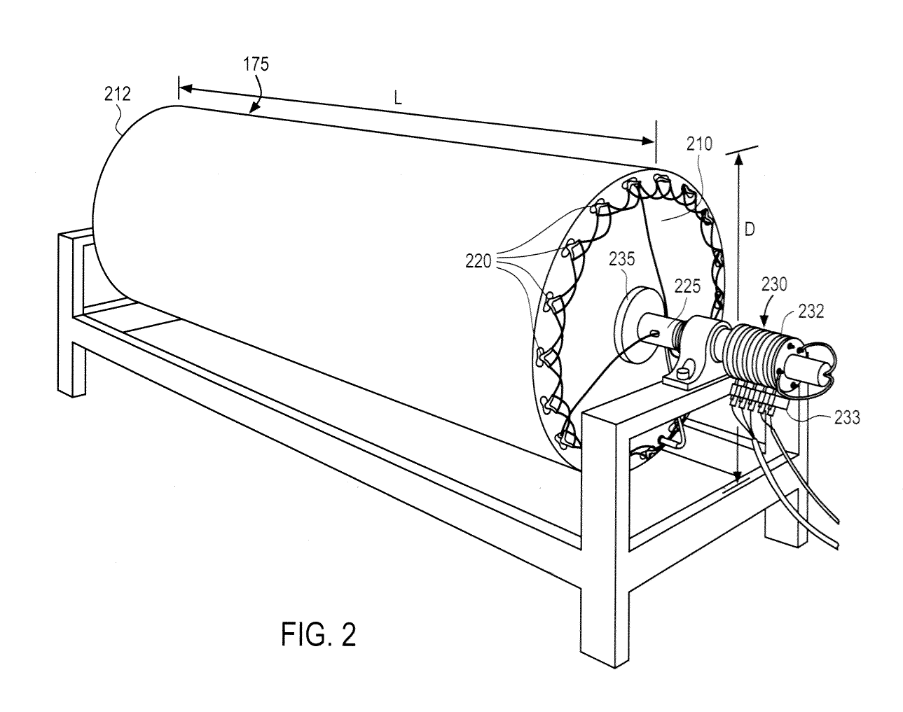

With reference to dryer section 130, a representative surface temperature or a cylinder or roller is on the order of 250° C. In one embodiment, a dryer cylinder or roller that uses electricity as a direct heat source in conjunction with a thermal super conducting material is described. FIG. 2 shows an embodiment of one cylinder or roller, such as cylinder or roller 175 from FIG. 1. As viewed, cylinder or roller 175 has a cylindrical body with length dimension L, that will vary with a particular need. Representative lengths are on the order of 1000 millimeters (mm) to 3000mm. A material for the cylinder body is a metal material such as stainless steel, carbon steel or other metal or alloy. Cylinder or roller 175 has a diameter, D, that will vary depending on need and may range, for example, from 400 mm to 2500mm. Cylinder or roller 175 is shown in FIG. 2 as a closed cylinder with closing head 210 on one end and closing head 212 on a second end. A material for the cylinder closing heads is, for example a metal material such as stainless steel, carbon steel or other metal or alloy.

With reference to closing head 210 in FIG. 2, cylinder or roller 175 includes a number of electrical heating rods 220 that extend from closing head 210 into cylinder or roller 175. The two terminal blocks (+, −) are on the same side of each heating rod extending from closing head 210. In one embodiment, each heating rod 220 is commercially available and includes a stainless steel tube (SUS304) with length on the order of 300 mm a wall thickness of 1.5 mm. In the embodiment shown in FIG. 2, cylinder or roller 175 has a length on the order of 2400 mm and a diameter, D, of approximately 800 mm. For a cylinder or roller this size, 18 electrical heating rods 220 are installed in cylinder or roller 175 at closing head 210 specifically around an outer circumferential edge of closing head 210. For a cylinder or roller this size, it will have a heating area on the order or 5.75 square meters (m²). If each heating element generates 1000 watts (w) of power with an operating voltage of 200 volts, the total starting power will be 18,000 kilowatts (kW) with an operating current on the order of 4.3 to 5 kW with a heat energy output of approximately 20,000 kilocalories (kcal) or more when combined with a thermally conductive material as described herein.

Spindle 225 is connected to closing head 210 through flange 235. A similar spindle and flange is connected to closing head end 212. That spindle, although not shown in FIG. 2, may be connected to a rotation source such as an electric motor suitable for rotating cylinder or roller 175 on the spindle. The spindles define a rotational axis for cylinder or roller 175.

Power (current) is supplied to each of the electric heating rods 220 through brushed machine 230. Brushed machine 230 is shown adjacent closing head 210. Brushed machine 230 includes conductive barrel 232 of multiple isolated rings. Each ring is a separate voltage and is isolated from the other rings. Individual leads from electrical heating rods 220 are electrically connected to individual rings. Heating rods 220 and the rings of barrel 232 rotate together. Barrel 232 is connected to spindle 220 and rotates on the spindle. Brushed machine 230 also includes brushes 233 that are stationary and make electrical contact with the rotating rings of barrel 232. A power supply (e.g., a 220 volt power supply) provides current to at least one pair of brushes. A surface of the rings should be sufficiently smooth to maintain consistent electrical contact during rotation.

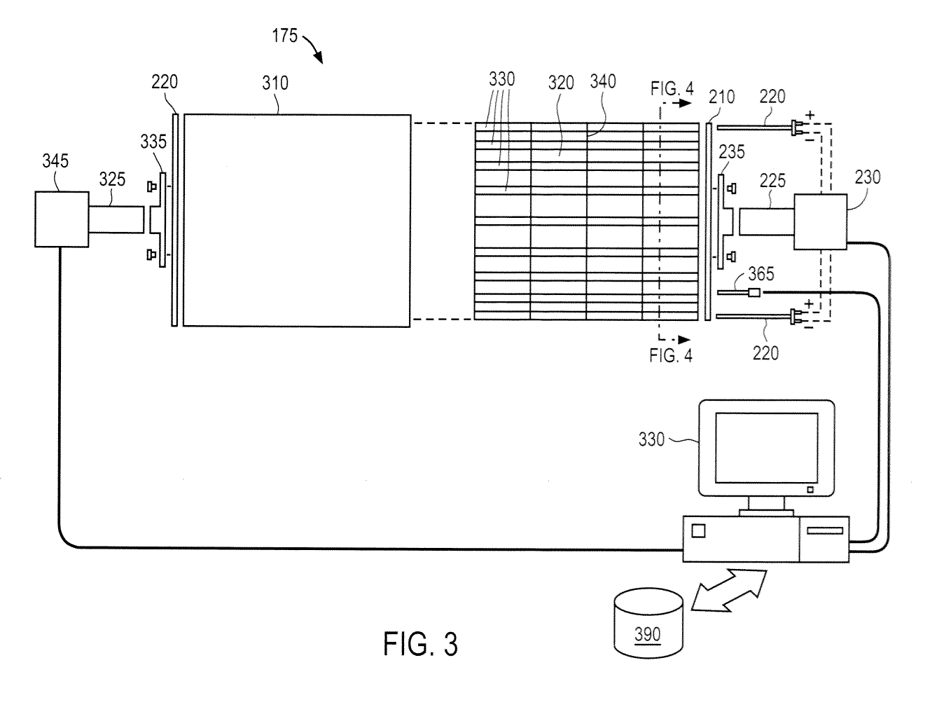

FIG. 3 shows an exploded side view of cylinder or roller 175. In this view, cylinder or roller 175 includes outer cylinder 310 and inner cylinder 320 each of metal material such as stainless steel, carbon steel or other metal or alloy. In one embodiment, outer cylinder may be one material such as stainless steel, and inner cylinder may be another material, such as iron or carbon steel. In one embodiment, outer cylinder 310 is a δ3.5 mm SUS 304 stainless steel and inner cylinder is δ6 mm iron material. When assembled, inner cylinder 320 is disposed within outer cylinder 310.

Referring to inner cylinder 320, the cylinder includes a cylindrical body having an outside diameter less than an inside diameter of outer cylinder 310. In an embodiment, wherein an inside or inner diameter of outer cylinder 310 is 796 mm and an outside or outer diameter of outer cylinder is 800 mm, an outside or outer diameter of inner chamber 320 is on the order of 765 mm to 785 mm defining an outer surface and a number of heating tubes 330 of a thermally conductive material disposed on an outer surface thereof adjacent an exterior surface of interior cylinder 320. The number of heating tubes on the outer surface of inner cylinder 320 in one embodiment is equivalent to the number of heating rods installed in cylinder or roller 175. In the example where cylinder or roller 175 had 18 heating rods 220 disposed therein (see FIG. 2), there would be 18 heating tubes 330 on the outer surface of inner cylinder 320 (spaced around the circumference of inner cylinder 320) so that each heating rod is disposed in a single heating tube. In one embodiment, each heating tube 330 is a seamless cylindrical body of a metal material such as carbon steel or stainless steel having an inside diameter on the order of 20 mm and an outside diameter on the order of 2.5 mm. Each tube 330 has a closed distal end and an open proximal end to receive heating rod 220 and a thermally conductive material. A diameter of tube 330 is sufficient to accept a heating rod therein. Once installed in a heating tube, a heating rod seals the open end of the heating tube by, for example, a sealing gasket associated with the heating tube and/or heating rod. Although heating tube 330 is described as a cylindrical body, it is appreciated that other shapes are suitable such as rectangular or a semi-cylindrical body with a planar side depending on application.

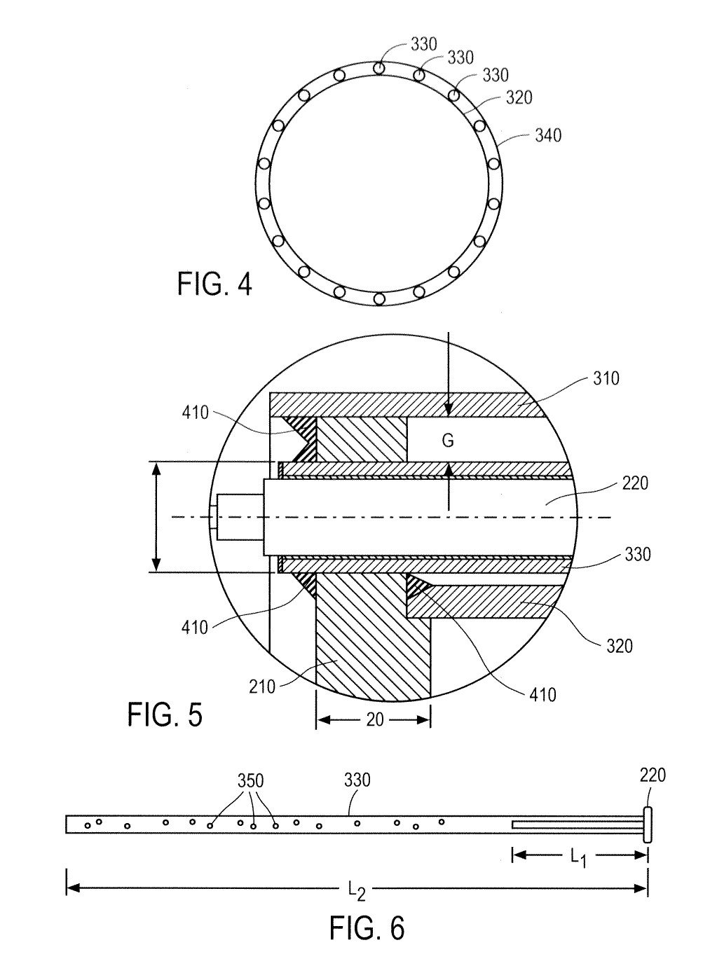

Each heating tube 330 may be connected to an exterior surface of inner cylinder 320 by a direct connection (e.g., a spot weld) and/or a support loop. FIG. 3 shows a number of support loops 340 extending over heating tubes 330 and around a circumference of inner cylinder 320. FIG. 4 shows a side view through line 4-4′ of FIG. 3. FIG. 4 shows inner cylinder 320 having heating tubes 330 on an exterior surface thereof and support loop 340 extending over the heating tubes such that heating tubes 330 are disposed between support loop 340 and inner cylinder 320. Each supporting tube 340 is a thermally connective material such as metal having a minimal thickness and width sufficient enough to support heating tubes 330 (e.g., a thickness and width on the order of 2 mm to 5 mm and a width on the order of 5 mm to 10 mm).

An inside diameter of outer cylinder 310 is sufficient to accommodate inner cylinder 320, including heating tubes 330 and support loops 340. In one embodiment, heating tubes 330 and support 340 fit snugly against or minimally adjacent an inner surface of outer cylinder 310. Representatively, the gap between the heating tubes and the cylinder wall is less than 5 centimeters (cm) to allow sufficient thermal conduction from heating tubes 330 to an exterior surface of outer cylinder 310. FIG. 5 shows a cross-sectional side view of a portion of roller 175 equivalent to the top right corner of the roller in FIG. 3 (as viewed) when assembled. FIG. 5 shows exterior heating tube 330 separated from an interior surface of outer cylinder 310 by gap, G. A minimum gap, G, would be zero meaning heating tube 330 contacts an interior surface of outer cylinder 310.

Referring again to FIG. 3, FIG. 3 shows closing head 210 and closing head 220 at opposite ends of cylinder or roller 175 defining a rotational axis for cylinder or roller 175. Each closing head may be attached to inner cylinder 320 and outer cylinder 310 to incase inner cylinder 320 within outer cylinder 310. One such technique is by welding closing heads to each cylinder 310. FIG. 5 illustrates welds 410 between closing head 210 and inner cylinder 330 and outer cylinder 320. In one embodiment, a temperature sensor is present in closing head 210. FIG. 3 shows temperature sensor 365 that is a thermocouple in the form of a rod of a representative length of 200 mm and a representative diameter of 14 mm to 16 mm. In one embodiment, temperature sensor 365 is inserted in through closing head 210 at a circumferential edge of the closing head (e.g., between adjacent heating tubes) and extends through closing head and into cylinder or roller 175 between inner cylinder 320 and outer cylinder 310. Although one temperature sensor is described, it is appreciated that there may be more than one temperature sensor associated with cylinder or roller 175 to measure and/or monitor a surface temperature of the cylinder or roller.

Returning to FIG. 3, FIG. 3 also shows flange 235 that may be connected by, for example, bolts to a center of closing head 210. Spindle 225 is then connected to flange 235. FIG. 3 shows spindle 225 having electric brushed machine 230 thereon. Brushed machine 230 provides current to each heating rod 220. At the opposite end of cylinder or roller 175 is closing head 220. Closing head 220 is connected to inner cylinder 330 and outer cylinder 310 by, for example, welds to close that end of outer cylinder or roller 175. FIG. 3 also shows flange 335 connected to a center of closing head 220. Finally, FIG. 3 shows spindle 325 connected to flange 335. Spindle 325 may be connected to motor 345 that turns spindle 325 to rotate cylinder or roller 175 in, for example, a paper making process.

FIG. 6 shows an embodiment of one heating tube 330 having heating rod 220 installed therein. As shown, in one embodiment, heating tube 330 has a length that is greater than a length of heating rod 220. Representatively, heating rod 220 has a length, L₁, on the order of 300 mm. Heating tube 330, in turn, has a representative length, L₂, of, one embodiment, equivalent to the length of inner chamber 320, e.g., 2400 mm. In another embodiment, a length, L₂, of heating tube 330 may be less than a length of inner chamber 320. For example, a length, L₂, of heating tube 330 may be one-half, one-third, or one-fourth a length of inner chamber 320. Representatively, where a length of inner chamber is on the order of 2400 mm, heating tube 330 is on the order of 600 mm. Heating tube 330 is intended to define a sealed volume when heating rod 220 is installed therein. Accordingly, each heating tube 330 is pressure tested for leaks by, for example, a 1.5 millipascal (mPa) pressure test. Further, an inside surface of heating tube 330 defining a volume in one embodiment is free of burrs or other debris or oil to provide a smooth, unvaried, and clean surface.

As shown in FIG. 6, heating tube 330 also contains an inorganic thermally conductive material or media 350. Thermally conductive material 350 is present in an amount sufficient to transfer heat from heating element 220 to the surface of heating tube 330 and the surface of outer cylinder 310. Suitable representative thermally conductive material is described in U.S. Pat. Nos. 6,132,823; 6,911,231; 6,916,430; 7,220,365 and United States Patent Publication No. 2005/0056807, which are incorporated by reference herein. In another embodiment, thermally conductive material 350 is an inorganic material that is a combination of oxides, titanium and/or silicon. One such combination is provided in Table 1.

TABLE 1

| | |
|---|---|
| sodium peroxide | 2.705% |
| disodium oxide | 2.505% |
| silicon | 1.6% |
| diboron trioxide | 0.505% |
| titanium | 0.405% |
| copper oxide | 0.405% |
| cobalt oxide | 0.255% |
| beryllium oxide | 0.255% |
| water, distilled, conductivity or of similar purity | 89.256% |
| dirhodium trioxide | 1.6% |
| trimanganese tetraoxide | 0.255% |
| strontium carbonate | 0.255% |

In an embodiment using the thermally conductive material described in Table 1, the material is introduced into each heating tube 330 in a representative range amount minus the water component, equivalent to 1/400,000 of the volume of a heating tube. In other words, a 2400 mm heating tube with a 20 mm inside diameter would have a volume of 3,215,360 mm³ and the thermally conductive material would be present in an amount of 8 mm³ by volume. Other amounts may also be suitable such as an amount ranging from 1/400,000 to 1/200,000 by volume. For those thermally conductive materials described in the referenced incorporated patent documents, other amounts of thermally conductive material may also be used. For example, U.S. Pat. No. 7,220,365 describes an inorganic thermally conductive material of cobalt oxide, boron oxide, calcium dichromate, magnesium dichromate, potassium dichromate, beryllium oxide, titanium diboride and potassium peroxide in amounts of 0.001 to 0.025 by volume.

In one embodiment, the thermally conductive material is introduced into each heating tube. Each tube is heated to evaporate the water component. The tube is then sealed (e.g., with a heating element inserted through a sealing gasket). Without wishing to be bound by theory, it is believed that the thermally conductive material operates by mechanically conducting heat generated by a heating element to the heating tube (e.g., solid particles of the thermally conductive material colliding with one another and with a all of the heating tube). The thermally conductive material in each heating tube 330 permits heat distribution through the tube and conducts the heat to the surface of cylinder or roller 175 (e.g., axially conducts heat).

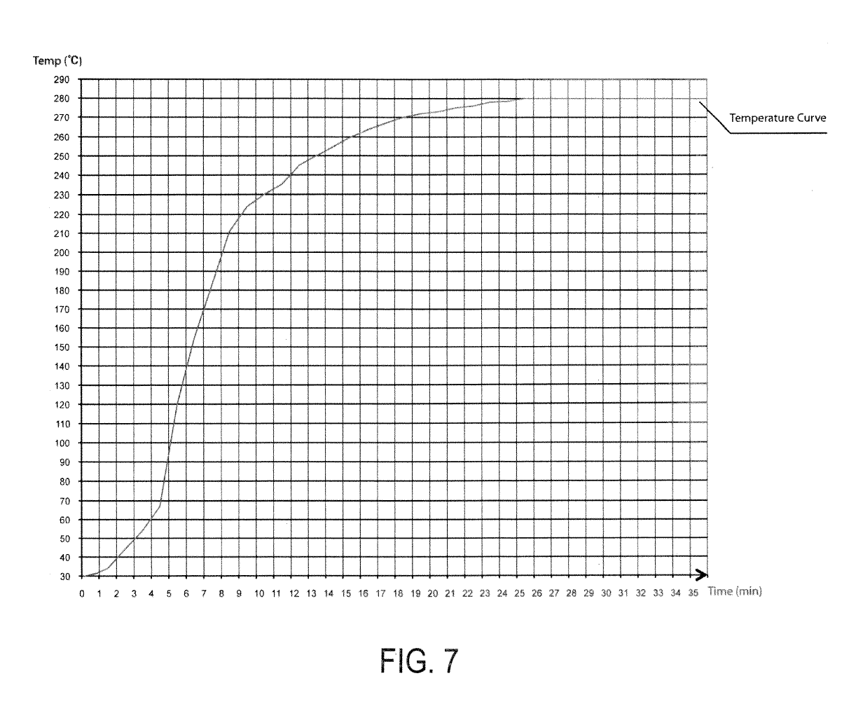

With 1 kW power provided by a heat source (e.g., an electrical heating rod), heating tube 330 including 1/400,000 by volume of the thermally conductive material described in Table 1 can generate on the order of 2000 kcal of heat or more on the surface of cylinder or roller 175 (on an outer surface of outer cylinder 310). FIG. 7 shows a temperature curve diagram of heating a dryer roller as described with length 2400 mm and a diameter of 800 mm and a thermally conductive material as described in Table 1 in an amount to 1/400,000 by volume in each heating tube. FIG. 7 shows that the surface temperature of a cylinder or roller (cylinder or roller 175), in this example, was heated to 250° C. in approximately 13 minutes and a target of 280° C. in approximately 25 minutes. Accordingly, the use of a thermally conductive material in heating tubes (such as heating tubes 330) along with a heat source can transfer the heat quickly and the temperature can be evenly distributed at the surface of a cylinder or roller. The thermal conductivity of the thermally conductive material can reach 14 mWatts/° C. and provide a heat flux of 27 mW/m².

In one embodiment, the temperature and/or rotation of roller 175 is automatically monitored and/or controlled. FIG. 3 shows controller or control computer 380 in communication with various components associated with cylinder or roller 175 to provide a centralized user interface for controlling the components and a synthesis reaction. It shall be appreciated that controller 380 and the various components may be configured to communicate through hardwires or wirelessly, for example, the system may utilize data lines which may be conventional conductors or fiber optic. Controller 380 may also communicate with one or more local databases 390 so that data or protocols may be transferred to or from local database(s) 390. For example, local database 390 may store one or a plurality of synthesis protocols for producing paper or other substrate (e.g., fabric), such protocols including protocols for a single roller cylinder or roller such as cylinder or roller 175 or multiple rollers used collectively. Furthermore, controller 380 may use local database(s) 390 for storage of information received from components, such as reports and/or status information.

Representatively, as described above, cylinder or roller 175 may be used to dry a substrate (e.g., paper, fabric) when heated to an appropriate temperature. Maintenance of an appropriate temperature is desired even where a substrate may tend to modify a surface temperature more at the point that the initial contact between the substrate and the cylinder or roller (when the substrate is at its wettest) then when the substrate is leaving the surface of the cylinder or roller. In one embodiment, ideal performance attempts to maintain an appropriate target temperature of a surface of cylinder or roller 175 despite the changing condition (e.g., drying) of the substrate in contact with the cylinder or roller. In such embodiment, the temperature of the surface of cylinder or roller 175 may be monitored and/or controlled by controller 380. For example, a processing protocol delivered to control computer 380 includes instructions for receiving temperature measurements from temperature sensor 365 (and any other temperature sensors) reflective of a surface temperature of cylinder or roller 175. Based on these measurements, instructions are provided in a machine-readable form to be executed by controller 380. Accordingly, controller 380 executes the instructions to increase or decrease the power output to one or more heating rods 220 to achieve a target temperature in a range f (e.g., 250° C. to 280° C.). Representatively, when a substrate is first contacting a surface of cylinder or roller 175 in its wettest state, controller 380 may increase the power to those heating rods 220 associated with a contact area of the cylinder or roller. Alternatively or additionally, when the substrate is about to leave a surface of cylinder or roller 175 and is therefore at its driest state, controller 380 may execute instructions to decrease the power output to those heating rods associated with a contact area of the cylinder or roller. It is appreciated that controller 380 may be increasing power to some heating rods 220 while at the same time decreasing power to other heating rods 220. Still further, controller 380 may be connected to motor 345 and control the rotational speed of cylinder or roller 175 based on program instructions to achieve a desired throughput and moisture content of a substrate.

In the above description with reference to the figures, a cylinder or roller for use in a paper production (e.g., paper drying) system is described. The configuration with electric heating and thermally conductive material in heating tubes makes maintenance (e.g., replacement of heating rods) relatively simple compared to prior art paper rollers. It is appreciated that the configuration of a heating tube with a heat source (e.g., resistive electric heating rod) and thermally conductive material to heat a thermally conductive surface of a body (e.g., a metal body) such as a cylinder or roller as described herein will have uses beyond paper production. Such uses include, but are not limited to, the production of textiles, fabrics and synthetic fibers including printing, dying and settings operations of any of these substrates or materials. For example, a roller or other configurations (e.g., body including a planar surface) as dictated by the production process can be used in the setting of polyester, nylon, polyamide or other synthetic filaments. Still further, configurations involving surface heating with heating tubes including a heat source and thermally conductive material may be used in the production of rare metals.

In the description above, for the purposes of explanation, numerous specific details have been set forth in order to provide a thorough understanding of the embodiments. It will be apparent however, to one skilled in the art, that one or more other embodiments may be practiced without some of these specific details. The particular embodiments described are not provided to limit the invention but to illustrate it. The scope of the invention is not to be determined by the specific examples provided above but only by the claims below. In other instances, well-known structures, devices, and operations have been shown in block diagram form or without detail in order to avoid obscuring the understanding of the description. Where considered appropriate, reference numerals or terminal portions of reference numerals have been repeated among the figures to indicate corresponding or analogous elements, which may optionally have similar characteristics.

It should also be appreciated that reference throughout this specification to “one embodiment”, “an embodiment”, “one or more embodiments”, or “different embodiments”, for example, means that a particular feature may be included in the practice of the invention. Similarly, it should be appreciated that in the description various features are sometimes grouped together in a single embodiment, figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

1. An apparatus comprising:
a thermally conductive body having a length, an exterior surface and an opposing interior surface;
a plurality of heating tubes adjacent the interior surface, the tubes having a length dimension that extends over a portion of the length of the body;
a plurality of heating elements disposed in a portion of respective ones of the plurality of heating tubes; and
a thermally conductive material disposed in each of the plurality of heating tubes.

2. The apparatus of claim 1, wherein the body comprises a cylindrical body having a diameter and a volume and the plurality of heating tubes are disposed in the volume and around the diameter of the first cylindrical body.

3. The apparatus of claim 2, wherein the cylindrical body comprises a first cylindrical body, the apparatus further comprising a second cylindrical body within the volume of the first cylindrical body, wherein the heating tubes are disposed between the first cylindrical body and the second cylindrical body.

4. The apparatus of claim 2, wherein each of the heating tubes comprise a volume and one of the plurality of electrical heating elements is disposed in less than the entire volume, and the thermally conductive material in each of the heating tubes is present in amount that is less than the remaining volume.

5. The apparatus of claim 1, wherein the thermally conductive material is a combination of the following substances:
sodium peroxide;
disodium oxide;
silicon;
diboron trioxide;
titanium;
copper oxide;
cobalt oxide;
beryllium oxide;
dirhodium trioxide;
trimanganese tetraoxide; and
strontium carbonate.

6. The apparatus of claim 2, further comprising a spindle coupled to on the cylindrical body, the spindle providing an axis on which end of the cylindrical body can rotate; and
a brushed machine coupled to the spindle and configured to rotate together with the cylindrical body,
wherein each of the plurality of heating elements comprises an electrical heating element and leads of the electrical heating elements are coupled to the brushed machine.

7. A method comprising:
contacting a substrate with a dryer, the dryer comprising:
a cylindrical body having a diameter and a length;
a plurality of heating tubes disposed around the diameter of the cylindrical body, the heating tubes having a length dimension that extends over a portion of the length of the body;
a plurality of electrical heating elements disposed in a portion of respective ones of the plurality of heating tubes; and
a thermal conducting material disposed in each of the plurality of heating tubes; and
removing moisture from the substrate.

8. The method of claim 7, wherein the substrate is paper.

9. The method of claim 7, wherein the substrate is fabric.

10. A method comprising:
contacting a substrate with an exterior surface of a heated body, the heated body having a length and an interior surface opposite the exterior surface, wherein the heated body is heated by a plurality of heating tubes adjacent the interior surface, each of the plurality of heating tubes comprising a heating element and a thermally conductive material; and
modifying the substrate.

11. The method of claim 10, wherein the heated body comprises a cylinder.

12. The method of claim 10, wherein the thermally conductive material is a combination of the following substances:
sodium peroxide;
disodium oxide;
silicon;
diboron trioxide;
titanium;
copper oxide;
cobalt oxide;
beryllium oxide;
dirhodium trioxide;
trimanganese tetraoxide; and
strontium carbonate.

13. The method of claim 10, wherein modifying comprises drying.

14. An apparatus comprising:
a body of a thermally conductive material comprising a first end and a closed end and defining a volume therein;
a heat element disposed in the volume of the body; and
a thermally conductive material disposed in the volume of the body, the thermally conductive material being a combination of the following substances:
sodium peroxide;
disodium oxide;
silicon;
diboron trioxide;
titanium;
copper oxide;
cobalt oxide;
beryllium oxide;
dirhodium trioxide;
trimanganese tetraoxide; and
strontium carbonate.

15. The apparatus of claim 14, wherein the body is a cylindrical body.
